(19) United States
(12) Patent Application Publication
(10) Pub. No.: US 2015/0045923 A1
(43) Pub. Date: Feb. 12, 2015

(54) MATERIAL CUTTING OPTIMIZATION APPARATUS, SYSTEM, AND METHOD

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHIH-KUANG CHANG, New Taipei (TW); XIN-YUAN WU, Shenzhen (CN); PENG XIE, Shenzhen (CN)

(21) Appl. No.: 14/448,786

(22) Filed: Jul. 31, 2014

(30) Foreign Application Priority Data
Aug. 7, 2013 (CN) 2013103426247

(51) Int. Cl. G05B 19/418

(52) U.S. Cl. CPC G05B 19/41865; G05B 2219/32086
USPC 700/97

(57) ABSTRACT

In a material cutting optimization method, a material cutting plate and a shape to be cut out are received. Then, a point cloud is generated according to the shape, and a maximal surrounding box of the material cutting plate is calculated. After that, a triangular mesh surface of the point cloud is constructed and a total area of triangles in the triangular mesh surface is computed. A maximum number of the shapes that can be contained in the material cutting plate is calculated and the shapes are arranged in the material cutting plate according to the total area of the triangles, using an iteration function.

### CROSS-REFERENCE TO RELTATED APPLICATIONS

This application claims priority to Chinese Patent Application No. 201310342624.7 filed on Aug. 7, 2013, in the China Intellectual Property Office, the contents of which are incorporated by reference herein.

### FIELD

The subject matter herein generally relates to a data optimization processing system and method, and more specifically relates to an apparatus, a method and a system of material cutting.

### BACKGROUND

Material cutting, such as cutting varieties of leather, rubber, plastic, fabric, and so on, with a blade of fixed shape, is an important procedure in manufacturing. To reducing waste in the material cutting procedure is a problem to be solved.

### BRIEF DESCRIPTION OF THE DRAWINGS

Implementations of the present technology will be described, by way of example only, with reference to the attached figures, wherein:

FIG. 1 is a block diagram of one embodiment of a hardware environment for executing a material cutting optimization system.

FIG. 2 is a block diagram of one embodiment of function modules of the material cutting optimization system in FIG. 1.

FIG. 3 is a flowchart of one embodiment of a material cutting optimization method.

FIG. 4 is a detail description of a block 310 in FIG. 3.

FIG. 5, FIG. 6, and FIG. 7 are respectively an example of a material cutting plate, a shape to be cut out, and an arrangement of the shapes in the material cutting plate.

FIG. 8 is an example of a plurality of points picked from a line.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device. The term “comprising,” when utilized, means “including, but not necessarily limited to”; it specifically indicates open-ended inclusion or membership in the so-described combination, group, series and the like.

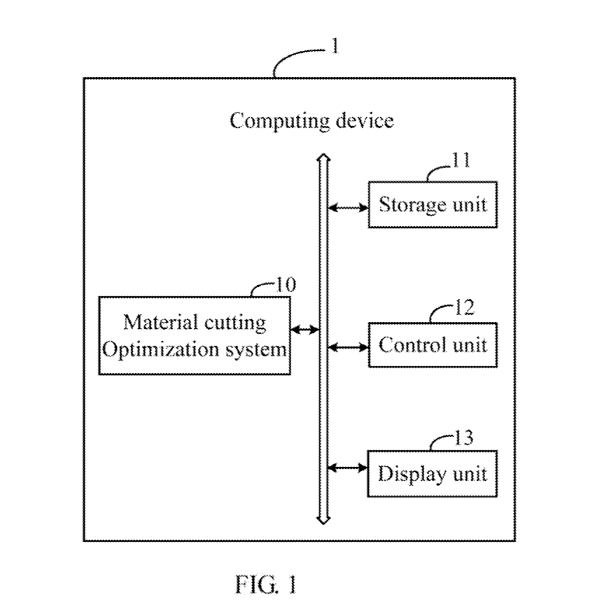

FIG. 1 is a block diagram of one embodiment of a hardware environment for executing a material cutting optimization system 10. The material cutting optimization system 10 is installed and runs in an apparatus, for example a computing device 1. The computing device 1 can include a storage unit 11, a control unit 12, and a display unit 13.

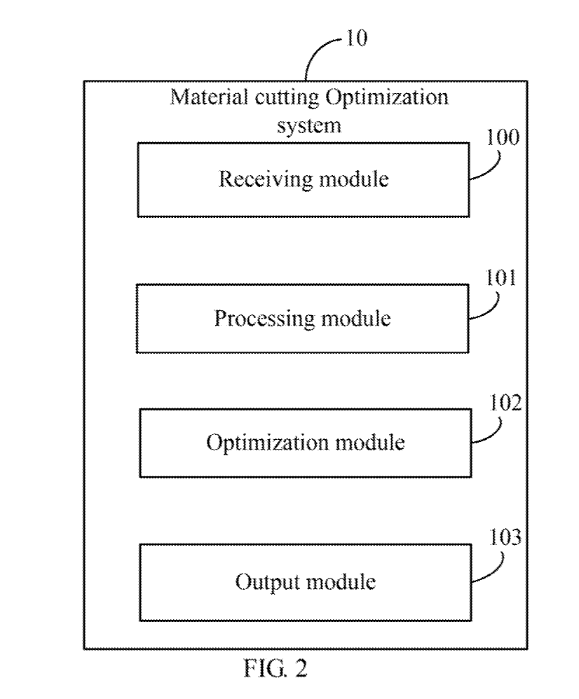

The material cutting optimization system 10 can include a plurality of function modules (shown in FIG. 2) that optimize material cutting in a material cutting plate according to the shapes of objects to be cut.

The storage unit 11 can include some type(s) of non-transitory computer-readable storage medium, for example a hard disk drive, a compact disc, a digital video disc, or a tape drive. The storage unit 11 stores computerized codes of the function modules of the material cutting optimization system 10.

The control unit 12 can be a processor, an application-specific integrated circuit (ASIC), or a field programmable gate array (FPGA), for example. The control device 12 can execute the computerized codes of the function modules of the material cutting optimization system 10 to realize the functions of the material cutting optimization system 10.

FIG. 2 is a block diagram of one embodiment of the function modules of the material cutting optimization system 10. The function modules can include a receiving module 100, a processing module 101, an optimization module 102, and an output module 103.

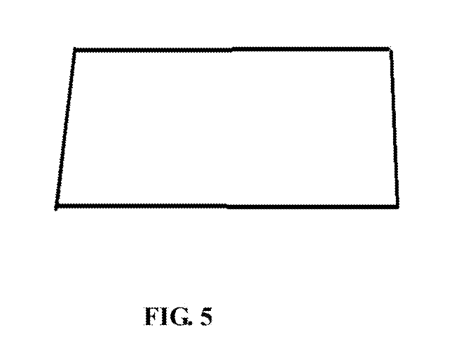

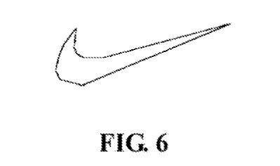

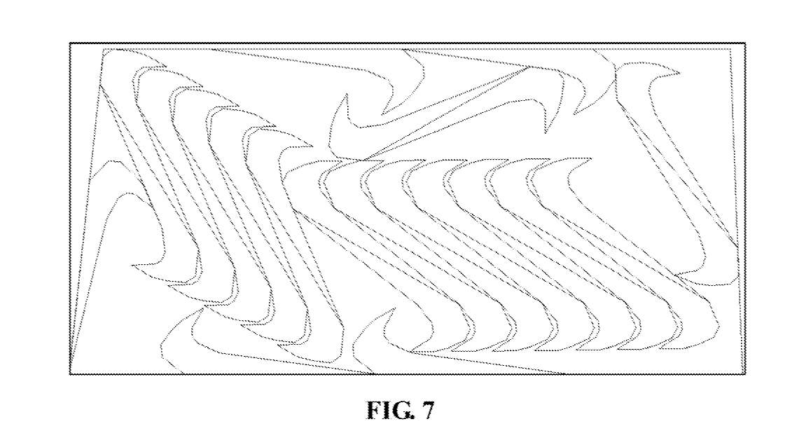

The receiving module 100 can receive a material cutting plate and a shape to be cut out. An example of the material cutting plate is illustrated in FIG. 5, and an example of the shape to be cut out is illustrated in FIG. 6. In one embodiment, a data format of the material cutting plate and the shape is Drawing Exchange Format (AutoCAD DXF), and the material cutting plate and the shape can be stored in the storage unit 11 of the computing device 1. The receiving module 100 can obtain the material cutting plate and the shape from the storage unit 11.

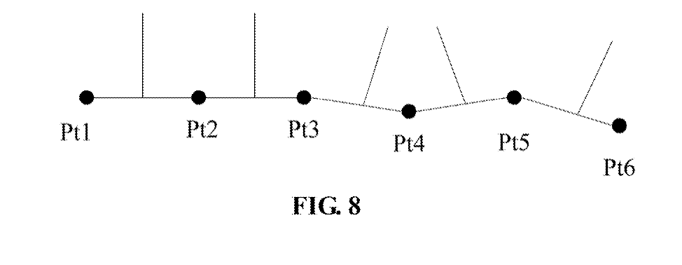

The processing module 101 can generate a point cloud according to the shape. In detail, the processing module 101 extracts lines that constitute the shape, computes a vector of each of the lines, and adjusts the vectors of the lines to point to the same direction. The processing module 101 further generates a point cloud according to the lines. In one embodiment, the processing module 101 picks a plurality of points at regular intervals from each of the lines, wherein the points can constitute the point cloud. In another embodiment, the processing module 101 can further connect every two adjacent points to generate (N−1) sub-lines, wherein N is the number of the points, and can filter the points according to angles of vectors of every two adjacent sub-lines. For example, when an angle of vectors of two adjacent sub-lines, such as a sub-line Pt1-Pt2 and a sub-line Pt2-Pt3 in FIG. 8, is less than a predetermined angle, then the processing module 101 deletes the point Pt2. The predetermined angle can be 1 degree, for example. Otherwise, when the angles of the sub-line Pt1-Pt2 and the sub-line Pt2-Pt3 are greater than or equal to the predetermined angle, the points Pt1, Pt2, and Pt3 are retained. After filtering, the points remaining can constitute the point cloud.

The processing module 101 further can calculate a maximal surrounding box of the material cutting plate. In one embodiment, assuming that minimum coordinates of boundary points in the material cutting plate are (PtMin[x], PtMin[y], PtMin[z]) and maximum coordinates of the boundary points are (PtMax[x], PtMax[y], PtMax[z]), the maximal surrounding box of the material cutting plate is constituted by points (PtMin[x], PtMin[y], PtMin[z]), (PtMin[x], PtMin[y], PtMaxl [z]), (PtMin[x], PtMax[y], PtMinl [z]), (PtMin[x], PtMax[y], PtMax[z]), (PtMax[x], PtMax[y], PtMax[z]), (PtMax[x], PtMax[y], PtMin[z]), (PtMax[x], PtMin[y], PtMax[z]), and (PtMax[x], PtMin[y], PtMin[z]).

In addition, the processing module 101 further can construct a triangular mesh surface of the point cloud, and compute a total area S of triangles in the triangular mesh surface.

The optimization module 102 can calculate a maximum number of the shapes that can be contained in the material cutting plate and arrange the shapes in the material cutting plate, according to the total area S using an iteration function. In one embodiment, the optimization module 102 calculates a value f(x) of the iteration function fix)=Min(SMax−N*S), wherein SMax is an area of the maximal surrounding box of the material cutting plate, N is the maximum number of the shapes that can be contained in the material cutting plate, and S is the total area of the triangles in the triangular mesh surface. The optimization module 102 further calculates a descending direction of the iteration function when the value f(x) is less than a predetermined value FunX, and calculates a value f(x)′ of the iteration function which is less than the value f(x) after the point cloud generated above has moved at least one step D along the descent direction, until there is no descent direction of the iteration function. The step D includes a translation distance, and a rotational angle. The optimization module 102 can arrange the shapes in the material cutting plate according to the translation distance and the rotational angle.

The output module 103 can output an arrangement of the shapes in the material cutting plate. In one embodiment, the arrangement of the shapes in the material cutting plate can be displayed on the display unit 13 of the computing device 1.

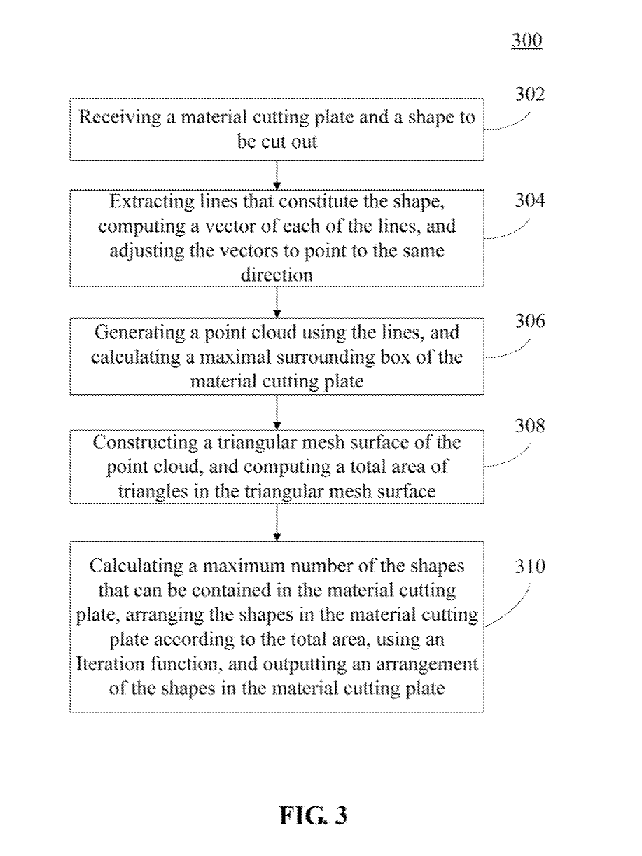

FIG. 3 is a flowchart of one embodiment of a material cutting optimization method.

Referring to FIG. 3, a flowchart is presented in accordance with an example embodiment illustrated. The example method 300 is provided by way of example, as there are a variety of ways to carry out the method. The method 300 described below can be carried out using the configurations illustrated in FIGS. 1 and 2, for example, and various elements of these figures are referenced in explaining example method 300. Each block shown in FIG. 3 represents one or more processes, methods or subroutines, carried out in the exemplary method 300. Additionally, the illustrated order of blocks is by example only and the order of the blocks can change according to the present disclosure. The exemplary method 300 can begin at block 302.

At block 302, a receiving module receives a material cutting plate and a shape. An example of the material cutting plate is illustrated in FIG. 5, and an example of the shape is illustrated in FIG. 6. In one embodiment, a data format of the material cutting plate and the shape is Drawing Exchange Format (AutoCAD DXF).

At block 304, a processing module extracts lines that constitute the shape, computes a vector of each of the lines, and adjusts the vectors of the lines to point to the same direction.

At block 306, a processing module generates a point cloud using the lines, and calculates a maximal surrounding box of the material cutting plate.

In one embodiment, the processing module 101 picks a plurality of points at regular intervals in each of the lines, wherein the points can constitute the point cloud. In another embodiment, the processing module 101 can further connect every two adjacent points to generate (N−1) sub-lines and can filter the points according to angles of vectors of every two adjacent sub-lines, wherein N is the number of the points. For example, when an angle of vectors of two adjacent sub-lines, such as a sub-line Pt1-Pt2 and a sub-line Pt2-Pt3 in FIG. 8, is less than a predetermined angle, the processing module 101 deletes the point Pt2. Otherwise, when an angle of the sub-line Pt1-Pt2 and the sub-line Pt2-Pt3 is greater than or equal to the predetermined angle, the points Pt1, Pt2, and Pt3 are retained. The determined angle can be 1 degree, for example. After filtering, the points remaining can constitute the point cloud.

In one embodiment, assuming that minimum coordinates of boundary points in the material cutting plate are (PtMin[x], PtMin[y], PtMin[z]) and maximum coordinates of the boundary points are (PtMax[x], PtMax[y], PtMax[z]), the maximal surrounding box of the material cutting plate can be constituted by points (PtMin[x], PtMin[y], PtMin[z]), (PtMin[x], PtMin[y], PtMaxl [z]), (PtMin[x], PtMax[y], PtMinl [z]), (PtMin[x], PtMax[y], PtMax[z]), (PtMax[x], PtMax[y], PtMax[z]), (PtMax[x], PtMax[y], PtMin[z]), (PtMax[x], PtMin[y], PtMax[z]), and (PtMax[x], PtMin[y], PtMin[z]).

At block 308, a processing module constructs a triangular mesh surface of the point cloud, and computes a total area S of triangles in the triangular mesh surface.

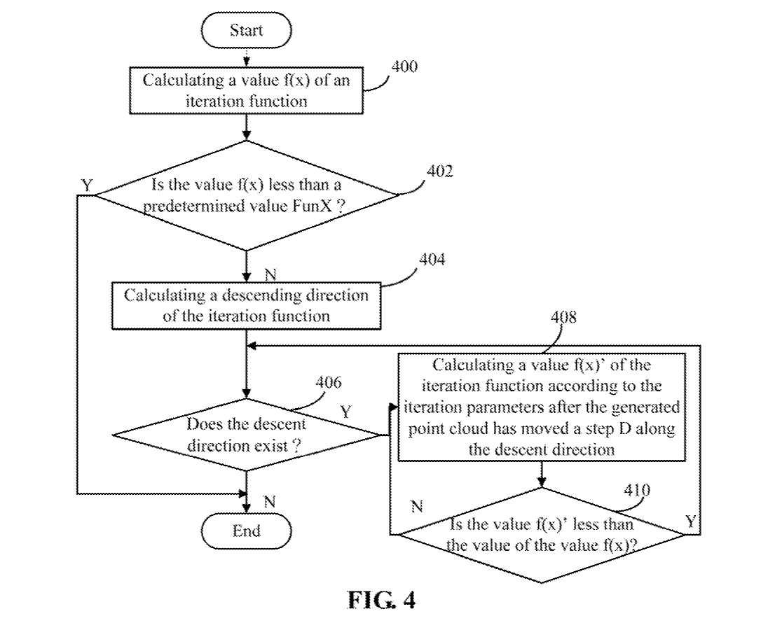

At block 310, an optimization module calculates a maximum number of the shapes that can be contained in the material cutting plate and arranges the shapes in the material cutting plate according to the total area S, using an iteration function, and an output module outputs an arrangement of the shapes in the material cutting plate. A detailed description of how to calculate the maximum number of the shapes that can be contained in the material cutting plate and arrange the shapes in the material cutting plate is contained in FIG. 4 and below.

FIG. 4 gives a detailed description of the block 310 in FIG. 3.

At block 400, the optimization module calculates a value f(x) of an iteration function f(x)=Min(SMax−N*S), wherein SMax is an area of the maximal surrounding box of the material cutting plate, N is the maximum number of the shapes that can be contained in the material cutting plate, and S is the total area of triangles in the triangular mesh surface.

At block 402, the optimization module determines if the value f(x) is less than a predetermined value FunX. Block 404 is implemented when the value f(x) is not less than the predetermined value FunX. The process ends after block 402, when the value f(x) is not less than the predetermined value FunX.

At block 404, the optimization module calculates a descent direction of the iteration function.

At block 406, the optimization module determines if the descent direction exists. When the descent direction of the iteration function does not exist, the process ends after block 406. When the descent direction of the iteration function still exists, block 408 is implemented.

At block 408, the optimization module calculates a value f(x)′ of the iteration function f(x)′=Min(SMax−N*S) after the point cloud generated above has moved one step D along the descent direction.

At block 410, the optimization module determines if the value f(x)′ is less than the value f(x). The process returns to block 404 when the value f(x)′ is less than the value f(x). The process returns to block 408 when the value f(x)′ is not less than the value f(x).

The embodiments shown and described above are only examples. Many details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A material cutting optimization method being executed by at least one processor of a computing device, the method comprising:
receiving a material cutting plate and a shape to be cut out;
generating a point cloud according to the shape;
calculating a maximal surrounding box of the material cutting plate, constructing a triangular mesh surface of the point cloud, and computing a total area of triangles in the triangular mesh surface;
calculating a maximum number of the shapes that are contained in the material cutting plate and arranging the shapes in the material cutting plate, according to the total area of the triangles; and
outputting an arrangement of the shapes in the material cutting plate.

2. The method according to claim 1, wherein a data format of the material cutting plate and the shape is Drawing Exchange Format (AutoCAD DXF), and the material cutting plate and the shape are stored in a storage unit the computing device.

3. The method according to claim 1, wherein the point cloud is generated according to the shape by:
exacting lines that constitute the shape, computing a vector of each of the lines, and adjusting the vectors of the lines to point to the same direction; and
picking a plurality of points at regular intervals in each of the lines, wherein the points constitute the point cloud.

4. The method according to claim 1, wherein the point cloud is generated according to the shape by:
exacting lines that constitute the shape, computing a vector of each of the lines, and adjusting the vectors of the lines to point to the same direction;
picking a plurality of points at regular intervals in each of the lines; and
connecting every two adjacent points to generate (N−1) sub-lines, and filtering the points according to angles of vectors of every two adjacent sub-lines, wherein N is the number of the points, and the point cloud comprises the points remaining after filtering.

5. The method according to claim 1, wherein the maximum number of the shapes is calculated by:
calculating a value f(x) of an iteration function f(x)=Min(SMax−N*S), wherein SMax is an area of the maximal surrounding box of the material cutting plate, N is the maximum number of the shapes that can be contained in the material cutting plate, and S is the total area of the triangles in the triangular mesh surface;
calculating a descent direction of the iteration function when the value f(x) is less than a predetermined value FunX; and
calculating a value f(x)′ of the iteration function which is less than the value f(x) after the point cloud generated above has moved at least one step D along the descent direction, until there is no descent direction of the iteration function, wherein the step D includes a translation distance and a rotational angle.

6. An apparatus, comprising:
a display unit;
a control unit; and
a storage unit storing one or more programs which, when executed by the control device, causes the control device to:
receive a material cutting plate and a shape to be cut out;
generate a point cloud according to the shape;
calculate a maximal surrounding box of the material cutting plate, construct a triangular mesh surface of the point cloud, and compute a total area of triangles in the triangular mesh surface;
calculate a maximum number of the shapes that are contained in the material cutting plate and arrange the shapes in the material cutting plate, according to the total area of the triangles; and
output an arrangement of the shapes in the material cutting plate to be displayed on the display unit.

7. The apparatus according to claim 6, wherein a data format of the material cutting plate and the shape is Drawing Exchange Format (AutoCAD DXF), and the material cutting plate and the shape are stored in the storage unit.

8. The apparatus according to claim 6, wherein the point cloud is generated according to the shape by:
exacting lines that constitute the shape, computing a vector of each of the lines, and adjusting the vectors of the lines to point to the same direction; and
picking a plurality of points at regular intervals in each of the lines, wherein the points constitute the point cloud.

9. The apparatus according to claim 6, wherein the point cloud is generated according to the shape by:
exacting lines that constitute the shape, computing a vector of each of the lines, and adjusting the vectors of the lines to point to the same direction;
picking a plurality of points at regular intervals in each of the lines;
connecting every two adjacent points to generate (N−1) sub-lines, and filtering the points according to angles of vectors of every two adjacent sub-lines, wherein N is the number of the points, and the point cloud comprises the points remaining after filtering.

10. The apparatus according to claim 6, wherein maximum number of the shapes is calculated by:
calculating a value f(x) of an iteration function f(x)=Min(SMax−N*S), wherein SMax is an area of the maximal surrounding box of the material cutting plate, N is the maximum number of the shapes that can be contained in the material cutting plate, and S is the total area of the triangles in the triangular mesh surface;
calculating a descent direction of the iteration function when the value f(x) is less than a predetermined value FunX; and
calculating a value f(x)′ of the iteration function which is less than the value f(x) after the point cloud generated above has moved at least one step D along the descent direction, until there is no descent direction of the iteration function, wherein the step D includes a translation distance and a rotational angle.

11. A non-transitory storage medium having stored thereon instructions that, when executed by a processor of a computing device, causes the processor to perform a material cutting optimization method, the method comprising:
receiving a material cutting plate and a shape to be cut out;
generating a point cloud according to the shape;
calculating a maximal surrounding box of the material cutting plate, constructing a triangular mesh surface of the point cloud, and computing a total area of triangles in the triangular mesh surface;
calculating a maximum number of the shapes that are contained in the material cutting plate and arranging the shapes in the material cutting plate, according to the total area of the triangles; and
outputting an arrangement of the shapes in the material cutting plate.

12. The non-transitory storage medium according to claim 11, wherein a data format of the material cutting plate and the shape is Drawing Exchange Format (AutoCAD DXF), and the material cutting plate and the shape are stored in a storage unit the computing device.

13. The non-transitory storage medium according to claim 11, wherein the point cloud is generated according to the shape by:
exacting lines that constitute the shape, computing a vector of each of the lines, and adjusting the vectors of the lines to point to the same direction; and
picking a plurality of points at regular intervals in each of the lines, wherein the points constitute the point cloud.

14. The non-transitory storage medium according to claim 11, wherein the point cloud is generated according to the shape by:
exacting lines that constitute the shape, computing a vector of each of the lines, and adjusting the vectors of the lines to point to the same direction;
picking a plurality of points at regular intervals in each of the lines; and
connecting every two adjacent points to generate (N−1) sub-lines, and filtering the points according to angles of vectors of every two adjacent sub-lines, wherein N is the number of the points, and the point cloud comprises the points remaining after filtering.

15. The non-transitory storage medium according to claim 11, wherein the maximum number of the shapes is calculated by:
calculating a value f(x) of an iteration function f(x)=Min(SMax−N*S), wherein SMax is an area of the maximal surrounding box of the material cutting plate, N is the maximum number of the shapes that can be contained in the material cutting plate, and S is the total area of the triangles in the triangular mesh surface;
calculating a descent direction of the iteration function when the value f(x) is less than a predetermined value FunX; and
calculating a value f(x)′ of the iteration function which is less than the value f(x) after the point cloud generated above has moved at least one step D along the descent direction, until there is no descent direction of the iteration function, wherein the step D includes a translation distance and a rotational angle.
